(19) United States
(12) Patent Application Publication
(10) Pub. No.: US 2025/0340258 A1
(43) Pub. Date: Nov. 6, 2025

(54) DRIVE WHEEL FOR TRACK SYSTEMS AND TRACK SYSTEM HAVING SAME

(71) Applicant: SOUCY INTERNATIONAL INC., Drummondville (CA)

(72) Inventors: Jeremie AUBIN-MARCHAND, Saint-Hugues (CA); Yan ROGER, Drummondville (CA)

(21) Appl. No.: 19/200,343

(22) Filed: May 6, 2025

Related U.S. Application Data
(60) Provisional application No. 63/643,221, filed on May 6, 2024.

(51) Int. Cl. B62D 55/125; B62D 55/10; B62D 55/14; B62D 55/24

(52) U.S. Cl. CPC B62D 55/125; B62D 55/10; B62D 55/14; B62D 55/244

(57) ABSTRACT

A drive wheel, which is for a track system, includes hub and rim portions, engaging members, recesses, a side support and a side opening. The rim portion is connected to, and disposed radially outwardly from, the hub portion. The engaging members are connected to, and extend radially outwardly from, the rim portion, are angularly spaced from one another. Each one of the recesses is defined between two adjacent engaging members, and is configured to receive an inner lug of an endless track. The side support is connected to one of the engaging members, extends toward an adjacent engaging member, and is radially spaced from the rim portion. The side opening is by the side support, a corresponding one of the plurality of engaging members, and part of the rim portion.

### CROSS-REFERENCE TO RELATED APPLICATION

The present application claims priority to U.S. Provisional Patent Application No. 63/643,221, filed May 6, 2024 entitled “Drive Wheel for Track Systems and Track System Having Same”, which is incorporated by reference herein in its entirety.

### TECHNICAL FIELD

The present application generally relates to drive wheels for track systems and track systems having drive wheels.

### BACKGROUND

Track systems are conventionally used with various types of vehicles such as agricultural vehicles, construction vehicles and recreational vehicles over a variety of different type of terrain such as mud, soil, gravel and asphalt.

Endless tracks of track systems may be subjected to lateral forces when the track systems are used on uneven terrain, when the track systems go over obstacles and/or when the track systems are connected to their vehicle with a camber angle.

This can result in premature wear of various components of the track system, such as wear of lugs of the endless tracks and/or wear of wheel assemblies of the endless track. In some instances, this can also cause detracking of the endless track.

Therefore, there is a desire for a technology that could mitigate the above-mentioned issues.

### SUMMARY

It is an object of the present technology to ameliorate at least some of the inconveniences present in the prior art.

According to one aspect of the present technology, there is provided a drive wheel for a track system. The drive wheel includes a hub portion, a rim portion, a plurality of engaging members, a plurality of recesses, a side support and a side opening. The rim portion is connected to the hub portion, and is disposed radially outwardly from the hub portion. The plurality of engaging members are connected to the rim portion. Each one of the plurality of engaging members is angularly spaced from one another, and extends radially outwardly from the rim portion. Each one of the plurality of recesses is defined between two adjacent engaging members of the plurality of engaging members, and is configured to receive an inner lug of a plurality of inner lugs of an endless track therein. The side support is connected to one of the plurality of engaging members, extends toward an adjacent one of the plurality of engaging members, and is radially spaced from the rim portion. The side opening is defined by the side support, a corresponding one of the plurality of engaging members, and part of the rim portion.

In some embodiments, the side support is configured to engage with a base of an inner lug of the plurality of inner lugs of the endless track.

In some embodiments, the side opening is configured to receive therethrough part of an inner lug of the plurality of inner lugs of the endless track.

In some embodiments, the side support extends from the one of the plurality of engaging members to an adjacent one of the plurality of engaging members.

In some embodiments, the side opening is further defined by the adjacent one of the plurality of engaging members.

In some embodiments, the side support further extends from the one of the plurality of engaging members toward an other adjacent one of the plurality of engaging members.

In some embodiments, the side support is spaced from the adjacent one of the plurality of engaging members.

In some embodiments, each one of the plurality of engaging members extends laterally beyond a first lateral side of the rim portion.

In some embodiments, the side support is one of a plurality of side supports, each one of the plurality of side supports being connected to a corresponding one of the plurality of engaging members.

In some embodiments, each one of the plurality of engaging members has a corresponding one of the plurality of the side supports connected thereto.

In some embodiments, one of the plurality of side supports is disposed on a first lateral side of the rim portion, and an other one of the plurality of side supports is disposed on a second lateral side of the rim portion.

In some embodiments, the side support is one of a plurality of side supports, each one of the plurality of side supports being connected to a corresponding one of the plurality of engaging members. Each one of the plurality of engaging members has a corresponding one of the plurality of the side supports connected thereto. The plurality of side supports forms a continuous side support structure that is laterally offset from a lateral side of the rim portion.

According to another aspect of the present technology, there is provided a track system. The track system includes a frame, a drive wheel assembly rotationally connected to the frame, at least one support wheel assembly rotationally connected to the frame, and an endless track surrounding the frame, the drive wheel assembly and the support wheel assembly. The drive wheel assembly includes the drive wheel according to the above aspect or according to the above aspect and one or more of the above embodiments. The endless track includes the plurality of lugs.

According to another aspect of the present technology, there is provided a drive wheel for a track system. The drive wheel includes a hub portion, a rim portion, a plurality of engaging members, a plurality of recesses and a plurality of side supports. The rim portion is connected to the hub portion, and is disposed radially outwardly from the hub portion. The plurality of engaging members are connected to the rim portion. Each one of the plurality of engaging members is angularly spaced from one another, extends radially outwardly from the rim portion, and extends laterally beyond a first lateral side of the rim portion. Each one of the plurality of recesses is defined between two adjacent engaging members of the plurality of engaging members, and is configured to receive an inner lug of a plurality of inner lugs of an endless track therein. Each one of the plurality of side supports is connected to one of the plurality of engaging members, extends toward an adjacent one of the plurality of engaging members, and is disposed laterally beyond the first lateral side of the rim portion. Each one of the plurality of engaging members has a corresponding one of the plurality of side supports.

In some embodiments, the drive wheel further defines a plurality of the side openings. Each one of the plurality of side openings is at least partially defined by a corresponding one of the plurality of side supports, a corresponding one of the plurality of engaging members, and part of the rim portion.

In some embodiments, the side support is configured to engage with a base of an inner lug of the plurality of inner lugs of the endless track.

In some embodiments, the side opening is configured to receive therethrough part of an inner lug of the plurality of inner lugs of the endless track.

In some embodiments, the side support extends from the one of the plurality of engaging members to an adjacent one of the plurality of engaging members.

In some embodiments, the side opening is further defined by the adjacent one of the plurality of engaging members.

In some embodiments, the side support further extends from the one of the plurality of engaging members toward an other adjacent one of the plurality of engaging members.

In some embodiments, the side support is spaced from the adjacent one of the plurality of engaging members.

In some embodiments, each one of the plurality of engaging members extends laterally beyond a first lateral side of the rim portion.

In some embodiments, the side support is one of a plurality of side supports, each one of the plurality of side supports being connected to a corresponding one of the plurality of engaging members.

In some embodiments, each one of the plurality of engaging members has a corresponding one of the plurality of the side supports connected thereto.

In some embodiments, one of the plurality of side supports is disposed on a first lateral side of the rim portion, and an other one of the plurality of side supports is disposed on a second lateral side of the rim portion.

In some embodiments, the side support is one of a plurality of side supports, each one of the plurality of side supports being connected to a corresponding one of the plurality of engaging members. Each one of the plurality of engaging members has a corresponding one of the plurality of the side supports connected thereto. The plurality of side supports forms a continuous side support structure that is laterally offset from a lateral side of the rim portion.

According to another aspect of the present technology, there is provided a track system having a frame, a drive wheel assembly rotationally connected to the frame, at least one support wheel assembly rotationally connected to the frame and an endless track surrounding the frame, the drive wheel assembly and the support wheel assembly. The drive wheel assembly includes the drive wheel according to the above aspect or according to the above aspect and one or more of the above embodiments. The endless track includes the plurality of inner lugs.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of an all-terrain vehicle with track systems according to embodiments of the present technology;

FIG. 2 is a perspective view taken from a top, rear, right side of a rear right track system of the all-terrain vehicle of FIG. 1;

FIG. 3 is a schematic cross-section view of an endless track of the rear right track system of FIG. 2, with the cross-section being taken along a lateral plane cutting through a longitudinal center point of an inner lug of the endless track;

FIG. 4 is a top plan view of a drive wheel of the rear right track system of FIG. 2;

FIG. 5 is a perspective view taken from a top, rear, right side of the drive wheel of FIG. 4;

FIG. 6 is a perspective view taken from a top, front, left side of the drive wheel of FIG. 4;

FIG. 7 is a close-up of a portion of the drive wheel of FIG. 5;

FIG. 8 is a top plan view of a drive wheel according to an alternative embodiment of the present technology;

FIG. 9 is a perspective view taken from a top, rear, right side of a drive wheel according to an alternative embodiment of the present technology;

FIG. 10 is a perspective view taken from a top, front, left side of the drive wheel of FIG. 9;

FIG. 11 is a close-up of a portion of the drive wheel of FIG. 10;

FIG. 12 is a top plan view of a drive wheel according to an alternative embodiment of the present technology;

FIG. 13 is a perspective view taken from a top, rear, right side of a drive wheel according to an alternative embodiment of the present technology;

FIG. 14A is a perspective view taken from a top, rear, right side of a drive wheel according to an alternative embodiment of the present technology;

FIG. 14B is a perspective view taken from a top, rear, right side of a drive wheel according to an alternative embodiment of the present technology;

FIG. 15 is schematic cross-sectional view of the track system of FIG. 2 connected to a vehicle with a camber angle;

FIG. 16A is a cross-sectional view of part of the track system of FIG. 2, taken along line 16A-16A in FIG. 1; and

FIG. 16B is a perspective view of the cross-section of FIG. 16A taken from a front, top, right side of the track system of FIG. 2.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

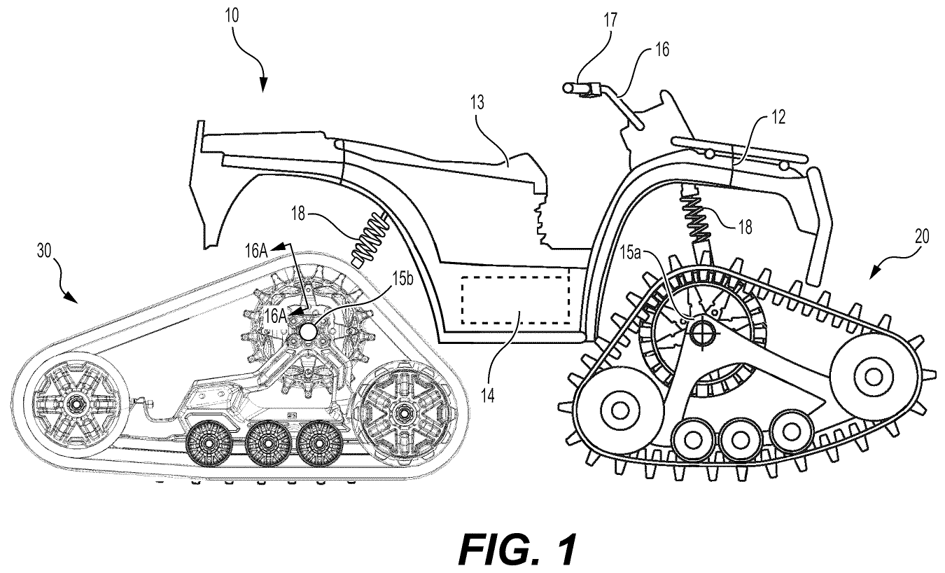

Referring to FIG. 1, the present technology will be described with reference to a vehicle 10. The vehicle 10 is an off-road vehicle 10. More precisely, the vehicle 10 is an all-terrain vehicle (ATV) 10. It is contemplated that in other embodiments, the vehicle 10 could be another type of recreational vehicle such as a snowmobile, a side-by-side vehicle (SSV) or a utility-task vehicle (UTV). A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 has two front track systems 20 (only the right one being shown in FIG. 1), and two rear track systems 30 (only the right one being shown in FIG. 1) in accordance with embodiments of the present technology. In some embodiments, the vehicle 10 could have more or less than four track systems.

The vehicle 10 includes a frame 12, a straddle seat 13 disposed on the frame 12, a powertrain 14 (shown schematically), a steering system 16, front and rear suspension systems 18, and the track systems 20, 30.

The powertrain 14, which is supported by the frame 12, is configured to generate power and transmit said power to the track systems 20, 30 via driving axles, thereby driving the vehicle 10. More precisely, the front track systems 20 are operatively connected to a front axle 15a of the vehicle 10 and, the rear track systems 30 are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20, 30 may be operatively connected to non-driven axle of unpowered vehicles (e.g., trailer). In yet other embodiments, the vehicle 10 could have more than two axles. For example, the vehicle 10 may be provided with a front axle, an intermediate axle and a rear axle, all or some of which could be operatively connected to the powertrain 14.

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20 relative to the frame 12 is changed, thereby enabling the vehicle 10 to turn in a desired direction. Other steering systems 16 are contemplated.

The suspension systems 18, which are connected between the frame 12 and the track systems 20, 30 allow relative motion between the frame 12 and the track systems 20, 30, and can enhance handling of the vehicle 10 by absorbing shocks and assisting in maintaining adequate traction between the track systems 20, 30 and the ground.

The track systems 20, 30 are configured to compensate for and/or otherwise adapt to the suspension systems 18 of the vehicle 10. For instance, the track systems 20, 30 are configured to compensate for and/or otherwise adapt to alignment settings, namely camber (i.e., a camber angle, “roll”), caster (i.e., a caster angle, “steering angle” and/or toe (i.e., a toe angle, “yaw”), which may be implemented by the suspension systems 18. As the vehicle 10 could have been originally designed to use wheels instead of the track systems, the alignment settings could originally have been set to optimize travel, handling, ride quality, etc. of the vehicle 10 with the use of wheels. Since the track systems 20, 30 are structurally different and behave differently from wheels, the track system 20, 30 may be configured to compensate for and/or otherwise adapt to the alignment settings to enhance their traction and/or other aspects of their performances and/or use.

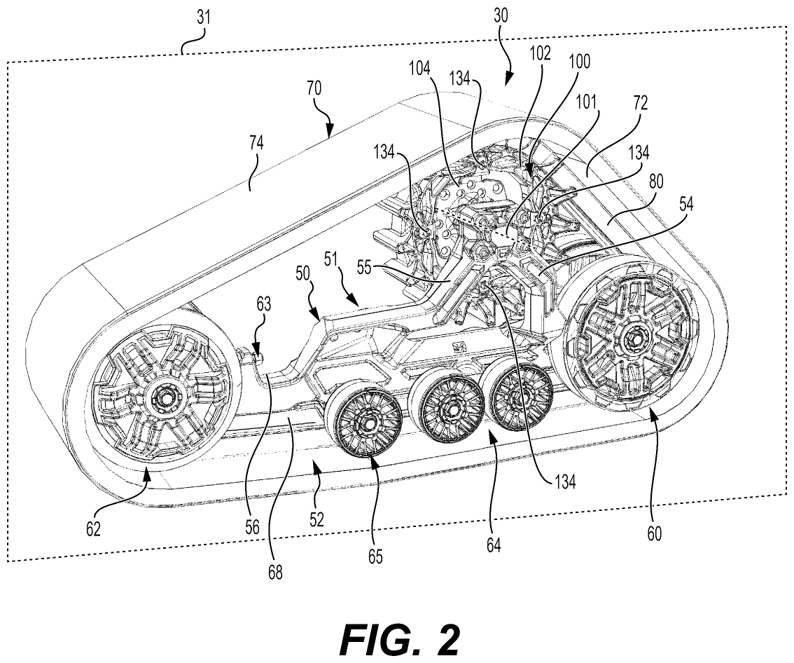

The front track systems 20 and the rear track systems 30 have features and components similar to one another. Thus, only the rear right track system 30, referred to simply as track system 30, will now be described in greater detail with reference to FIG. 2.

The track system 30 includes a drive wheel assembly 100, which may sometimes be referred to as a sprocket wheel assembly. The drive wheel assembly 100 is operatively connected to the driving axle 15b such that in response to the driving axle 15b rotating, the drive wheel assembly 100 rotates about a drive wheel axis 101. Rotation of the drive wheel assembly 100 can drive the track system 30 by engaging with an endless track 70. The drive wheel assembly 100, along with its engagement with the endless track 70, will be described in greater detail below.

The track system 30 further includes a frame 50. The frame 50 defines an inner lateral side 51 and an outer lateral side 52, with the inner lateral side 51 being closer to the vehicle 10 than the outer lateral side 52. The inner and outer lateral sides 51, 52 are defined consistently with inner and outer sides of a longitudinal center plane 31 of the track system 30. In some instances, the inner lateral side 51 of the track system 30 may be referred to as the left side of the track system 30, and the outer lateral side 52 of the track system 30 may be referred to as right side of the track system 30. In the present embodiment, part of the frame 50 extends along the longitudinal center plane 31. In some embodiments, the longitudinal center plane 31 can be defined by the frame 50.

The frame 50 includes a leading frame member 54, a trailing frame member 55 and a lower frame member 56. The leading and trailing frame members 54, 55 are jointly connected around the driving axle 15b, the joint connection being positioned laterally outwardly from the drive wheel assembly 100. The leading frame member 54 extends forwardly and downwardly from the joint connection and connects to a forward portion of the lower frame member 56. The trailing frame member 55 extends rearwardly and downwardly from the joint connection and connects to a rearward portion of the lower frame member 56. The lower frame member 56, which is positioned below the joint connection, extends generally parallel to the forward direction of travel of the vehicle 10. In the present embodiment, the leading, trailing and lower frame members 54, 55, 56 are integral. It is contemplated that in other embodiments, the leading, trailing and lower frame members 54, 55, 56 could be distinct members connected to one another.

It is contemplated that in other embodiments, the configuration of the frame 50 could differ without departing from the scope of the present technology. For instance, it is contemplated that in some embodiments, the frame 50 could include more or less than three members. In some embodiments, one or more of the leading, trailing and lower frame members 54, 55, 56 could be pivotally connected to one another.

With continued reference to FIG. 2, the track system 30 further includes a front idler wheel assembly 60, a rear idler wheel assembly 62, and support wheel assemblies 64, 65. It is contemplated that in other embodiments, the track system 30 could have a different number of wheel assemblies (e.g., only one idler wheel assembly and/or four or more support wheel assemblies). Each one of the front and rear idler wheel assemblies 60, 62 and the support wheel assemblies 64, 65 includes wheels spaced in the lateral direction. In other embodiments, one or more of the front and rear idler wheel assemblies 60, 62 and the support wheel assemblies 64, 65 may only include a single wheel in the lateral direction.

The front idler wheel assembly 60 is rotationally connected to a front end of the lower frame member 56.

The support wheel assemblies 64, 65 are disposed longitudinally rearwardly from the front idler wheel assembly 60, and are rotationally connected to the lower frame member 56. In some instances, the support wheel assemblies 64, 65 may be connected to the lower frame member 56 via biasing assemblies (not shown). In the illustrated embodiment, the support wheel assembly 64 includes a tandem wheel assembly (i.e., wheels spaced in the longitudinal direction) disposed on the inner lateral side 51 (not shown), an outer tandem wheel assembly disposed on the outer lateral side 52. The rear support wheel assembly 65 includes a wheel disposed on the inner lateral side 51 (not shown) and a wheel disposed on the outer lateral side 52. It is contemplated that the configuration of the support wheel assemblies 64, 65 may differ from one embodiment to another. For example, the tandem wheel assemblies may be omitted and/or there could be four support wheel assemblies.

The rear idler wheel assembly 62 is rotationally connected to a rear end of the lower frame member 56. In the illustrating non-limiting embodiment, the rear idler wheel assembly 62 is connected to the lower frame member 56 via a tensioner 63. The tensioner 63 is operable to adjust the tension in the endless track 70 by moving the rear idler wheel assembly 62 away or toward the frame 50. It is contemplated that in some embodiments, the tensioner 63 may be connected to the front idler wheel assembly 60 instead of the trailing idler wheel assembly 62. In other embodiments, the tensioner 63 may be omitted.

The track system 30 also includes a guide rail 68. The guide rail 68 is connected to the frame 50. More specifically, the guide rail 68 is connected to an underside of the lower frame member 56. In some embodiments, the guide rail 68 may be connected to the lower frame member 56 by a support structure. The guide rail 68 is positioned and configured such that when the track system 30 is in a resting state, a bottom of the guide rail 68 is spaced from an inner surface 72 of the endless track 70. The guide rail 68 is resiliently deformable, and can assist in limiting deformation of the endless track 70 (e.g., in a vertical direction), while also assisting in guiding the support wheel assemblies 64, 65 and guiding the endless track 70, which can reduce likelihood of the endless track 70 from detracking. The guide rail 68 is made from a material having a low coefficient of friction with the endless track 70, such as ultra-high molecular weight polyethylene (UHMW-PE). The guide rail 68 is described in greater detail in U.S. Provisional Application No. 63/643,226, the entirety of which is incorporated by reference herewith.

Still referring to FIG. 2, the track system 30 also includes the endless track 70. The endless track 70 extends around components of the track system 30, notably around the frame 50, the front and rear idler wheel assemblies 60, 62 and the support wheel assemblies 64, 65. The endless track 70 has the inner surface 72 and an outer surface 74. The inner surface 72 of the endless track 70 has the lugs 80, which are configured to, inter alia, engage with the drive wheel assembly 100. In the present embodiment, there is a single set of longitudinally spaced lugs 80. It is contemplated that in other embodiments, there could be two or more sets of longitudinally spaced lugs 80.

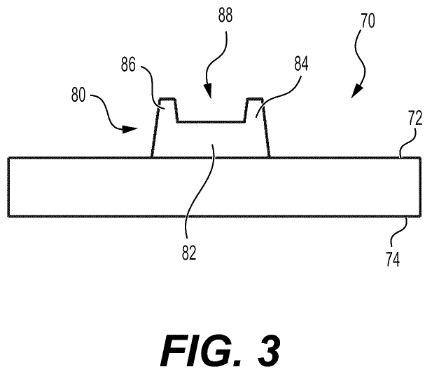

Referring to FIG. 3, a description of the lugs 80 will be provided. As the lugs 80 are similar, only one will be described herein. The lug 80 has a base portion 82, an extending portion 84 disposed on one lateral side of the base portion 82, and an extending portion 86 disposed on the other lateral side of the base portion 82. The extending portions 84, 86 extend generally, from the perspective of FIG. 3, vertically upwardly from the base portion 82 (extend generally radially with reference to the drive wheel assembly 100). In some instances, the extending portions 84, 86 extend orthogonally from the base portion 82. The extending portions 84, 86 define therebetween a recess 88. As will be described below, the recess 88 is configured to receive part of the drive wheel assembly 100 therein.

The lateral sides of the lug 80 are sloped, such that a width of the base portion 82 at a bottom thereof is greater than a width at a top thereof, and a width of the lug 80 at a top of the base portion 82 is greater than a width of the lug 80 at a top of the extending portions 84, 86. Likewise, a width of the extending portion 84 at a bottom thereof is greater than a width at a top thereof, and a width of the extending portion 86 at a bottom thereof is greater than a width at a top thereof. In some embodiments, the lateral sides of the lug 80 may not be sloped. It will be noted that the lug 80 is stiffer at the base portion 82 than at the extending portion 84, 86 because there is more material at the base portion 82 than at the extending portion 84, 86 (in part due to the presence of the recess 88, and/or in part due to the sloped configuration of the lateral sides).

The outer surface 74 of the endless track 70 has a tread (not shown) defined thereon. It is contemplated that the tread could vary from one embodiment to another. In some embodiments, the tread could depend on the type of vehicle on which the track system 30 is to be used and/or the type of ground surface on which the vehicle 10 is destined to travel. In the present embodiment, the endless track 70 is an endless polymeric track. It is contemplated that in some embodiments, the endless track 70 could be constructed of a wide variety of materials and structures.

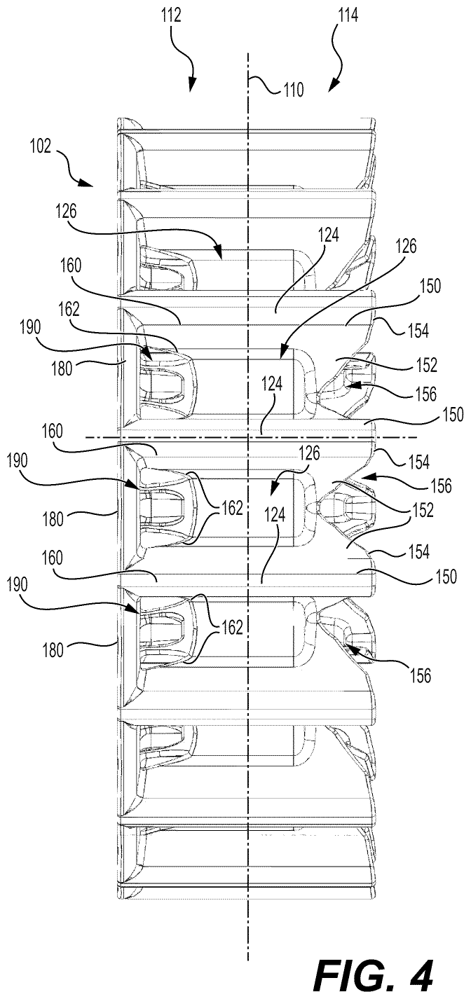

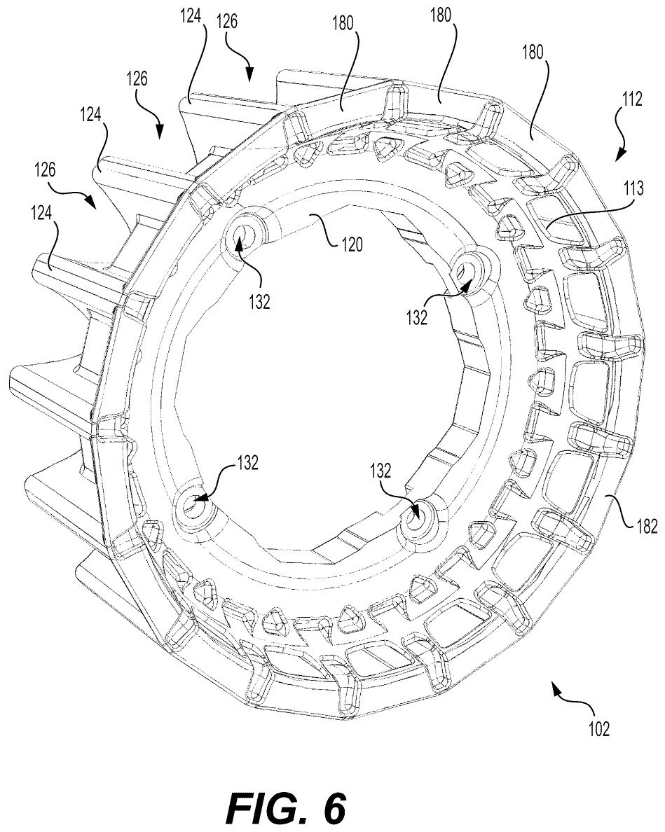

Referring to FIGS. 4 to 7, the drive wheel assembly 100 according to an embodiment of the present technology will now be described in greater detail. It will be noted that while the drive wheel assembly 100 is described with reference to the rear right track system 30, the drive wheel assembly 100 may be used with the rear left track system 30 and/or with the front track systems 20.

The drive wheel assembly 100 includes a drive wheel 102 and a spindle 104 (shown in FIG. 2). The spindle 104 is rotationally fixed to the drive wheel 102, and operatively connected to the driving axle 15b. Thus, in response to the driving axle 15b rotating, the spindle 104 rotates with the driving axle 15b about the drive wheel axis 101, which in turn causes the drive wheel 102 to also rotate about the drive wheel axis 101.

The drive wheel 102 has a longitudinal center plane 110 that defines a left side 112 thereof and a right side 114 thereof, with the left side 112 being closer to the vehicle 10 than the right side 114. In the illustrated embodiment, the right side 114 is closer to the frame 50 than the left side 112.

The drive wheel 102 has a hub portion 120 that is configured to connect to the spindle 104.

The hub portion 120 defines four recesses 130. The four recesses 130 are equally angularly spaced from one another. More specifically, the four recesses 130 are spaced from one another by about 90 degrees. It is contemplated that the number and/or disposition of the recesses 130 may vary from one embodiment to another. For example, in one embodiment, the hub portion 120 may define three recesses spaced by about 120 degrees from one another.

The hub portion 120 further defines four apertures 132. Each one of the four apertures 132 is received in a corresponding one of the four recesses 130. The four apertures 132 are configured to receive fasteners 134 (shown in FIG. 2) therein for fastening the spindle 104 to the drive wheel 102. In some embodiments, the hub apertures 132 may not be disposed within recesses 130. In some embodiments, the spindle 104 may be integral with the drive wheel 102.

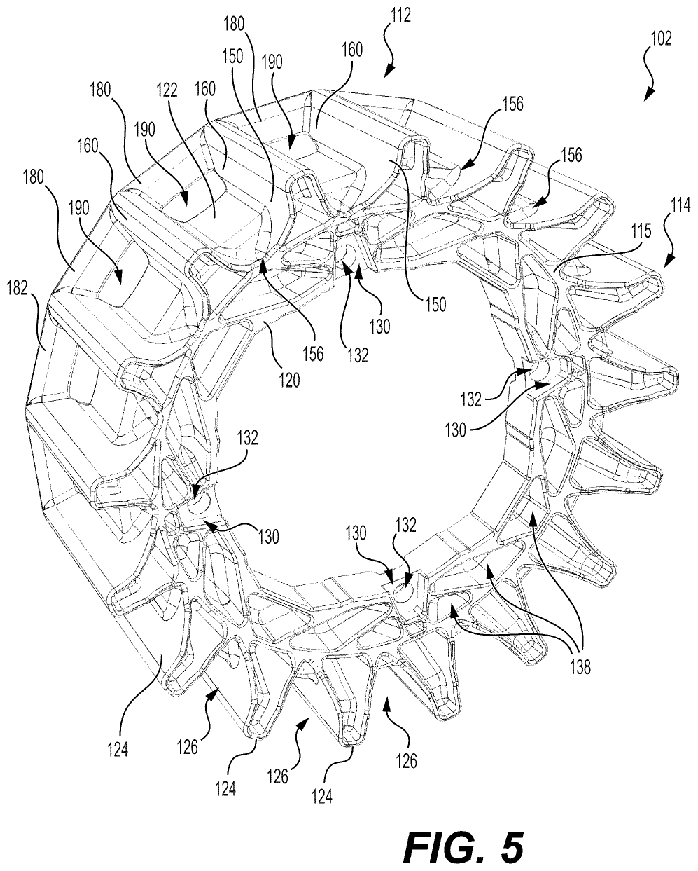

The hub portion 120 also defines a plurality of recesses 138 (only some of which are labelled in FIG. 5). The recesses 138 can assist in reducing the amount of material used to manufacture the drive wheel 102, thereby reducing a weight of the drive wheel 102. It is contemplated that the recesses 138 may be omitted.

The drive wheel 102 also has a rim portion 122 that extends radially outwardly from the hub portion 120.

The drive wheel 102 further has a plurality of engaging members 124 connected to the rim portion 122. In the present embodiment, the engaging members 124 the extend from the rim portion 122, such that the engaging members 124 and the rim portion 122 are integral. The drive wheel 102 further defines a plurality of recesses 126. More specifically, each one of the plurality of recesses 126 is defined, in part, by two adjacent engaging members 124. As will be described below, the recesses 126 are configured to receive part of the lugs 80 therein.

With continued reference to FIGS. 2 to 7, the engaging members 124 are angularly spaced from one another, and are disposed all around on a perimeter of the rim portion 122. As the engaging members 124 are all similar, only one engaging member 124 will now be described in greater detail.

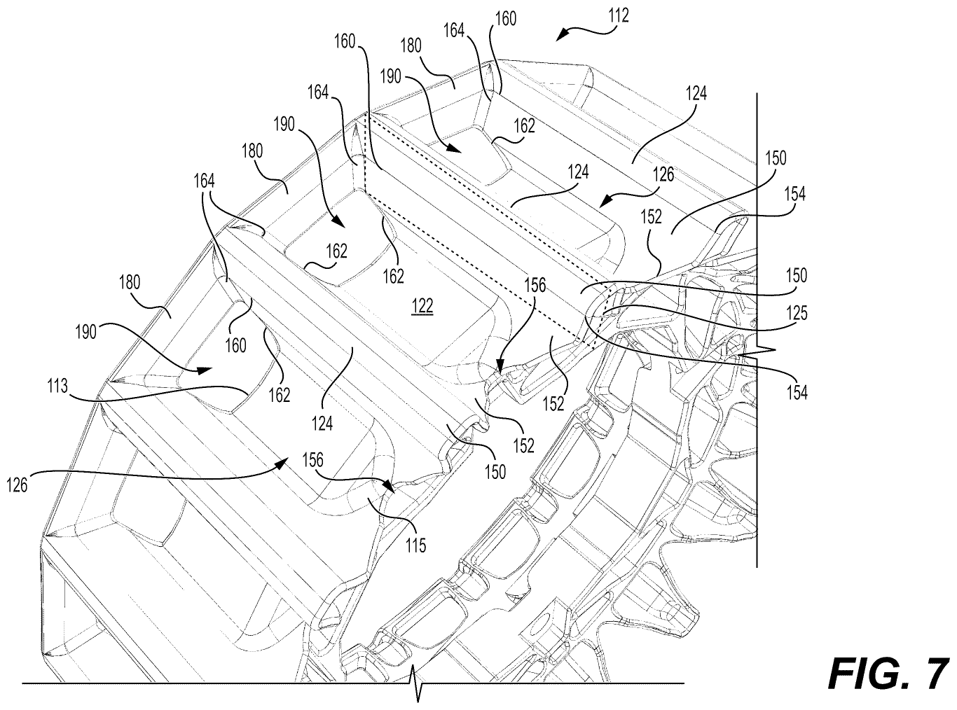

The engaging member 124 extends radially outwardly from the rim portion 122. The engaging member 124 also extends laterally outwardly from the rim portion 122. More specifically, the engaging member 124 has an outer portion 150 that extends beyond a right lateral side 115 (FIGS. 5 and 7) of the rim portion 122, and an outer portion 160 that extends beyond a left lateral side 113 (FIGS. 5 and 7) of the rim portion 122.

The engaging member 124 is symmetrical about a center plane 125 (FIG. 7). Thus, only features of the engaging member 124 disposed on one side of the center plane 125 will be described.

The outer portion 150 has a lower segment 152 and a side segment 154. The lower segment 152, which is radially lower the side segment 154, extends laterally outwardly as well as radially outwardly from a radially inner point of the rim portion 122. In some embodiments, the lower segment 152 may extend from a radially outer point of the hub portion 120. The configuration of the lower segment 152, along the symmetrical configuration of the engaging members 124 and the similarity between the engaging members 124 is such that adjacent engaging members 124 define a side recess 156 therebetween. As will be described below, the side recess 156 is configured to receive part of the lug 80 therein.

The side segment 154 extends radially outwardly from the lower segment 152. An upper end of the side segment 154 defines a top of the engaging member 124.

The outer portion 160, on the other end, has a lower segment 162 that extends laterally from a radially outer point of the rim portion 122. The lower segment 162 also extends partially radially outwardly such that a laterally outermost point of the lower segment 162 is disposed radially outwardly from a laterally innermost point of the lower segment 162. In some embodiments, the lower segment 162 may only extend in the lateral direction.

The outer portion 160 further has a side segment 164 that extends radially outwardly from the lower segment 162. The side segment 164 also extends partially laterally, such that a radially outermost point of the side segment 164 is disposed laterally outwardly from a radially innermost point of the side segment 164.

The drive wheel 102 also includes a plurality of side supports 180 connected to respective engaging members 124. As the side supports 180 are all similar, only one will be described in detail herewith.

The side support 180 is connected to two engaging members 124. More specifically, in the present embodiment, the side support 180 is connected to the side segment 164 of the outer portion 160 of two adjacent engaging members 124, such that the side support 180 extends from the outer portion 160 of one engaging member 124 to the outer portion 160 of an adjacent engaging member 124. It can thus be said that in the present embodiment, each engaging member 124 has two side supports 180 connected thereto, one on either side of the center plane 125.

The side support 180 is radially spaced from the rim portion 122. The side support 180 is also laterally spaced from the rim portion 122 (i.e., the side support 180 is laterally spaced from the left lateral side 113).

In the illustrated embodiment, the plurality of side supports 180 extend all around the drive wheel 102. Thus, the plurality of side supports 180 form a continuous side support structure 182. As will be described below, it is contemplated that the configuration of the side supports 180 may vary. For instance, the side supports 180 may be connected to every other engaging members 124. As will be described below, in some embodiments, the side support 180 may only be connected to one engaging member 124.

In some instances, the presence of the side supports 180 can assist in increasing structural integrity of the drive wheel 102. As will be described in greater detail below, the side supports 180 are configured to engage with the lugs 80, specifically the base portion 82 of the lugs 80, of the endless track 70 for, notably, guiding the endless track 70.

The drive wheel 102 further defines a plurality of side openings 190. Each one of the side openings 190 is in part defined by the rim portion 122, the lower segments 162 of the outer portions 160 of two adjacent engaging members 124, and the side support 180. The side openings 190 are laterally offset from the rim portion 122 (i.e., at least partially laterally offset from the left lateral side 113 of the rim portion 122). As will be described in greater detail below, the side openings 190 are configured to receive part of the lugs 80 therein.

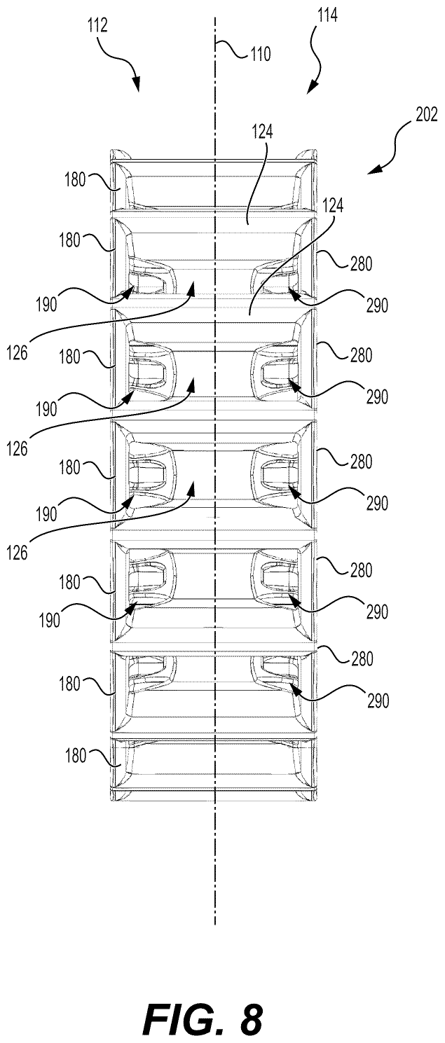

Referring now to FIG. 8, a drive wheel 202 according to an alternative embodiment of the present technology will be described. Features of the drive wheel 202 similar to those of the drive wheel 102 have been labeled with the same reference numerals unless indicated otherwise, and will not be re-described in detail herewith.

The drive wheel 202 notably differs from the drive wheel 102 in that the drive wheel 202 further has side supports 280 in addition to the side supports 180. The side supports 280, which are similar to the side supports 180, are disposed on the right side 114 of the drive wheel 202. The drive wheel 202 also defines side openings 290 on the right side 114 of the drive wheel 202. The side openings 290 are similar to the side openings 190,. Thus, the drive wheel 202, unlike the drive wheel 102, is symmetrical about the longitudinal center plane 110.

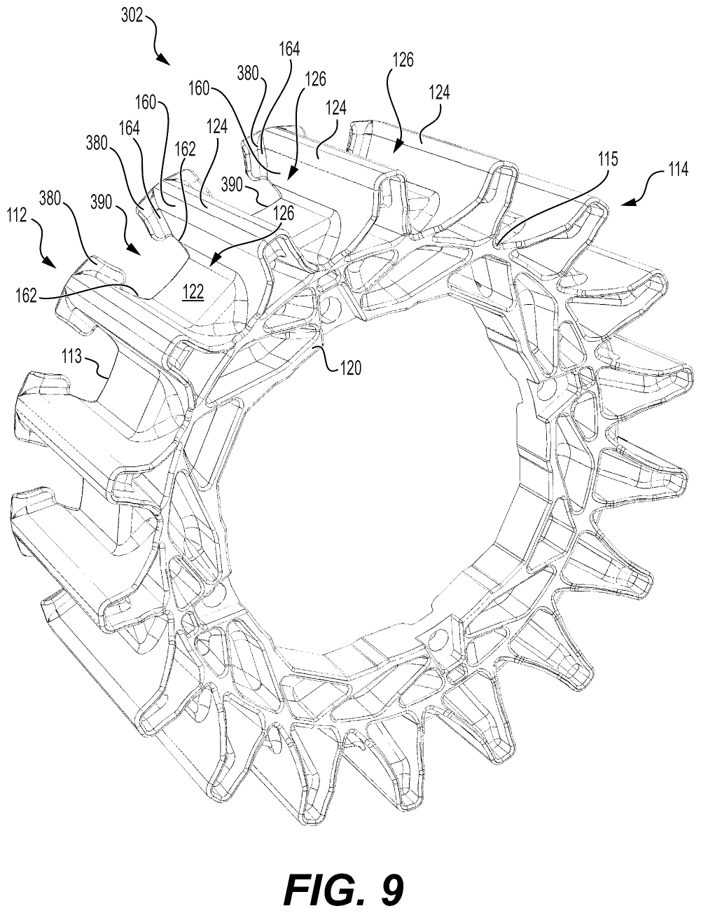

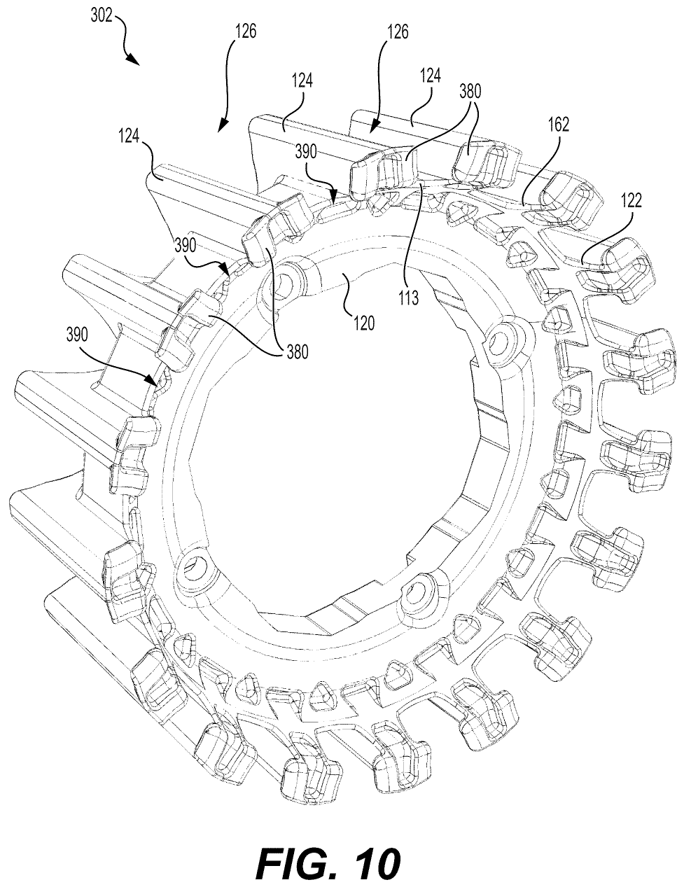

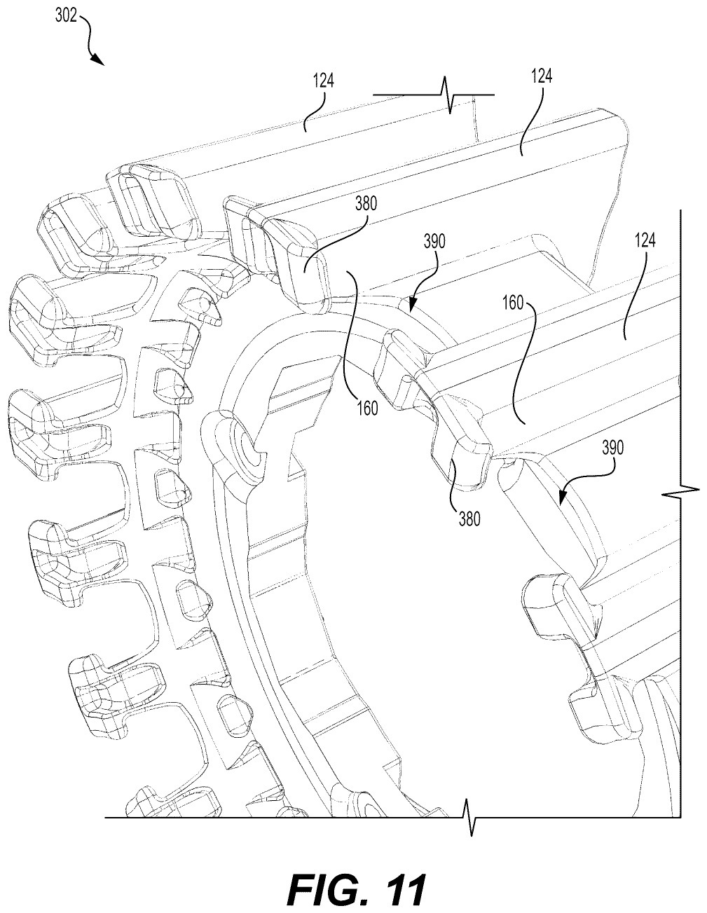

Referring to FIGS. 9 to 11, a drive wheel 302 according to an alternative embodiment of the present technology will be described. Features of the drive wheel 302 similar to those of the drive wheel 102 have been labeled with the same reference numerals unless indicated otherwise, and will not be re-described in detail herewith.

The drive wheel 302 differs from the drive wheel 102, in that the drive wheel 302 has a plurality of side supports 280 instead of the side supports 180. Each side support 380 is connected to a respective engaging member 124. As the side supports 380 are similar to one another, only one side support 380 will be described in detail herewith.

The side support 380 is connected to a single engaging member 124. More specifically, in the present embodiment, the side support 380 is connected to the side segment 164 of the outer portion 160 of one of the engaging members 124. The side support 380 extends on either side of the center plane 125 toward a corresponding adjacent engaging member 124, but without connecting thereto. It is contemplated that in some embodiments, the side support 380 may only extend on one side of the center plane 125. Thus, in the present embodiment, each side support 380 is spaced from adjacent side supports 380. This configuration of the side support 380 can reduce the amount of material required to manufacture the drive wheel 302. It is contemplated that in some embodiments, only every other engaging member 124 may have a side support 380 connected thereto.

The side support 380, like the side support 180, is radially spaced from the rim portion 122. Additionally, the side support 380 is laterally spaced from the rim portion 122 (i.e., the side support 380 is laterally spaced from the left lateral side 113 of the rim portion 122). Thus, unlike in the drive wheel 102, the side supports 380 do not form a continuous side support structure 182.

The drive wheel 302 further defines a plurality of side openings 390. Each one of the side openings 390 is in part defined by the rim portion 122, the lower segments 162 of the outer portions 160 of two adjacent engaging members 124, and part of two adjacent side supports 380. The side openings 390 are laterally offset from the rim portion 122 (i.e., at least partially laterally offset from the left lateral side 113).

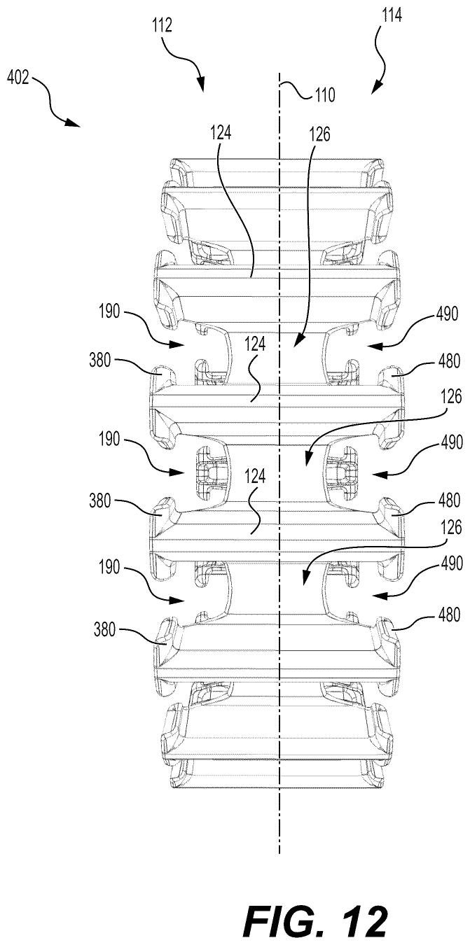

Referring to FIG. 12, a drive wheel 402 according to an alternative embodiment of the present technology is shown. Features of the drive wheel 402 similar to those of the drive wheel 302 have been labeled with the same reference numerals unless indicated otherwise and will not be re-described in detail herewith.

The drive wheel 402 notably differs from the drive wheel 302 in that the drive wheel 402 further has side supports 480 and defines side openings 390 on the right side 114 thereof. The side supports 480 are similar to the side supports 380, and the side openings 490 are similar to the side openings 390. Thus, the drive wheel 402, unlike the drive wheel 302, is symmetrical about the plane 110.

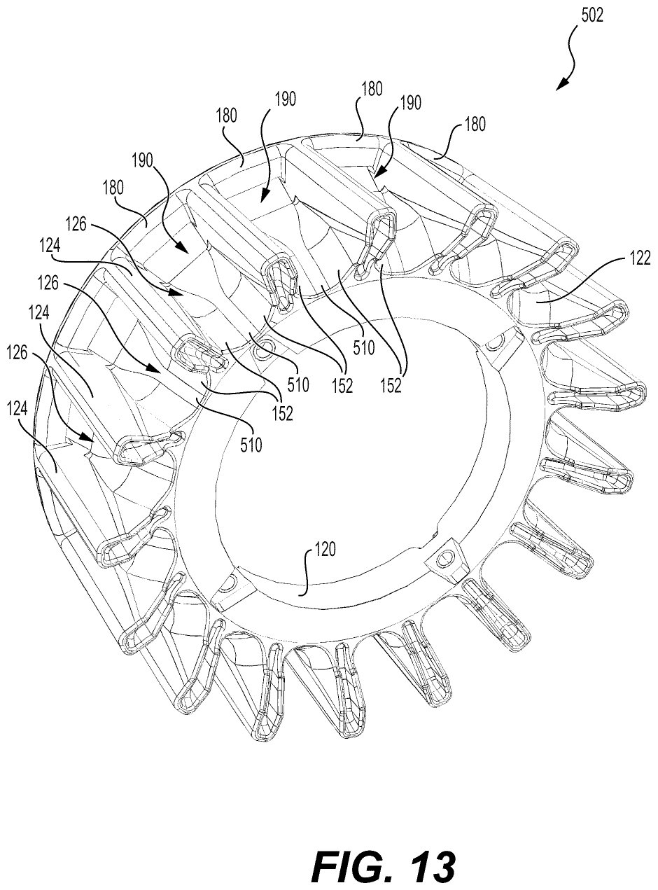

Referring to FIG. 13, a drive wheel 502 according to an alternative embodiment of the present technology is shown. Features of the drive wheel 502 similar to those of the drive wheel 102 have been labeled with the same reference numerals unless indicated otherwise and will not be re-described in detail herewith.

The rim portion 122 of the drive wheel 502 has a plurality of sloped sections 510. In the present embodiment, each recess 126 has a respective sloped section 510 defined therein. It is contemplated that in some embodiments, the sloped sections 510 could be provided in every other recess 126. As the sloped sections 510 are all the same, only one sloped section 510 will be described in detail herewith.

The sloped section 510 is sloped toward a center of the drive wheel 502. In the present embodiment, the sloped section 510 is oriented to the right side 114. It is contemplated that in other embodiments, the sloped section 510 could be oriented to the left side 112. It is also contemplated that in some embodiments, the sloped sections 510 could have alternating orientations. For example, half of the sloped sections 510 may be oriented to the left and half of the sloped sections 510 may be oriented to the right.

The sloped section 510 is connected to the outer portions 150 of two adjacent engaging members 124. More specifically, the sloped section 510 is connected to the lower segments 152 of two adjacent engaging members 124. Thus, in the drive wheel 502, the sloped section 510 generally replaces the side recess 156 present in the drive wheel 102.

When the drive wheel 502 is rotating and driving the endless track 70, the sloped sections 510 can assist in evacuating debris such as compacted snow or mud.

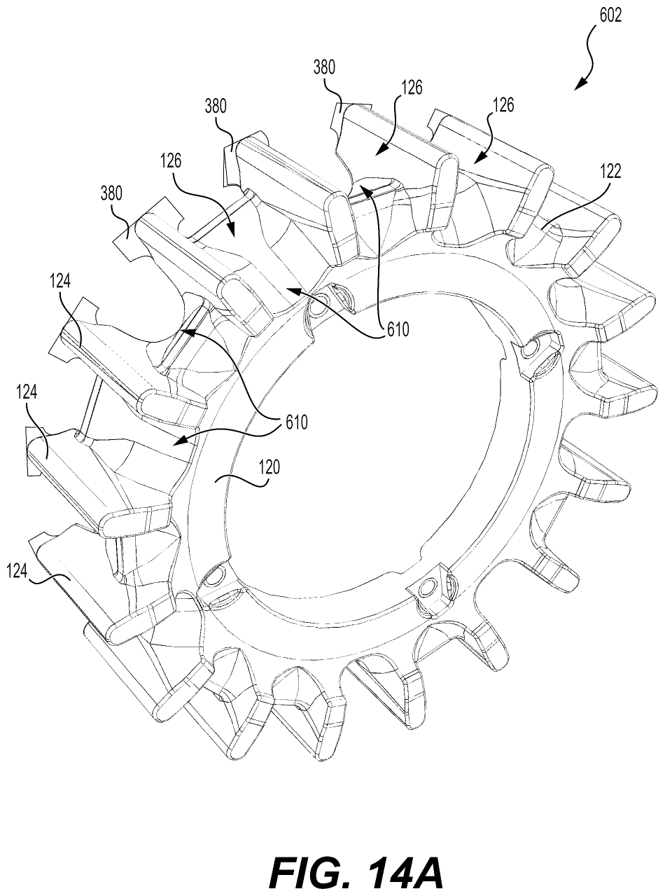

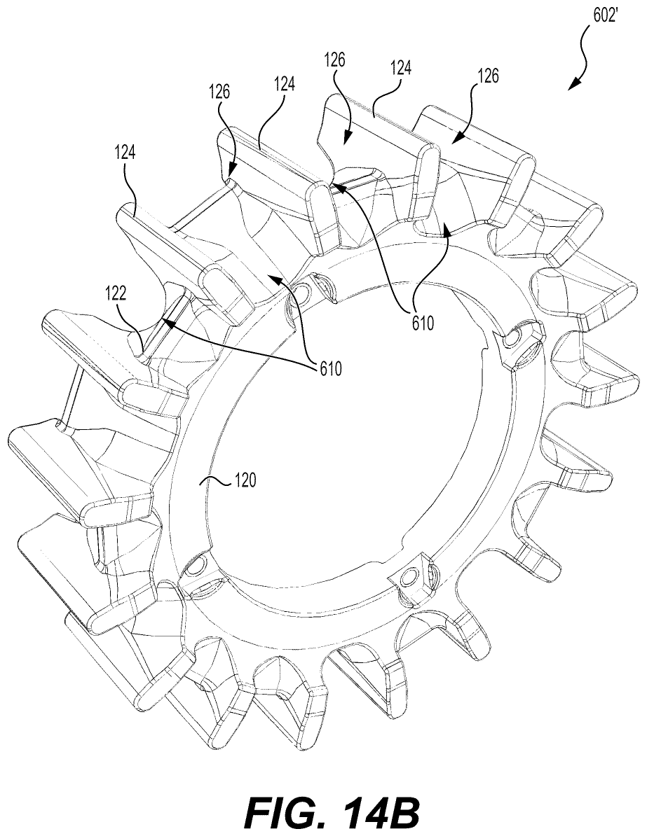

Referring to FIG. 14A, a drive wheel 602 according to an alternative embodiment of the present technology is shown. Features of the drive wheel 602 similar to those of the drive wheel 502 have been labeled with the same reference numerals unless indicated otherwise and will not be re-described in detail herewith.

The rim portion 122 of the drive wheel 602 has a plurality of sloped sections 610. More specifically, each sloped section 610 is defined in a respective recess 126. The sloped sections 610 are similar to the sloped sections 510, and will therefore not be re-described in detail herewith. The sloped sections 610 differ from the sloped sections 510, in that the sloped sections 610 are disposed in alternating orientations. In more details, some sloped sections 610 are oriented toward the right side 114, and other sloped sections 610 are oriented toward the left side 112. The drive wheel 602 also has a reduced width in the lateral direction, to minimize the surface upon which debris build-up may occur.

Referring to FIG. 14B, a drive wheel 602′ according to an alternative embodiment of the present technology is shown. The drive wheel 602′ differs from the drive wheel 602 in that the drive wheel 602′ does not have any side supports 380.

It is contemplated that features of one of the drive wheels 102, 202, 302, 402 may be combined with features of another one of the drive wheels 102, 202, 302, 402. For example, in some embodiments, a drive wheel may have the side supports 380 on the left lateral side 112, and the side supports 180 forming the continuous support structure 182 on the right lateral side 114. Any such variation is contemplated. In another embodiment, a drive wheel may be provided with the side supports 180 on both sides, but without defining the side openings 190.

Referring back to FIGS. 2 to 7 and the drive wheel 102, the drive wheel assembly 100 in use will now be described.

As mentioned above, the drive wheel assembly 100 rotates in response to a rotation of the driving axle 15b. More specifically, rotation of the driving axle 15b causes the spindle 104 to rotate about the drive wheel axis 101, which in turn causes the drive wheel 102 to rotate. In turn, the drive wheel 102 engages the endless track 70, and causes the endless track 70 to move, which drives the track system 30 forward (or backward, depending on a direction of rotation of the drive wheel 102).

The engagement between the drive wheel 102 and the endless track 70 will now be described in greater detail.

As the drive wheel 102 rotates about the axis drive wheel axis 101, the lugs 80 engage with the drive wheel 102. The engagement between one lug 80 and the one drive wheel 102 will be described.

The base portion 82 of the lug 80 is received in the recess 126, the extending portion 84 is received in the side recess 156, and the extending portion 86 is received in the side opening 190.

In this position, front and/or rear sides of the base portion 82 are engaged with two adjacent engaging members 124. The side support 180 engages a lateral side of the base portion 82. Additionally, the extending portions 84, 86 can engage the lateral sides 113, 115 of the rim portion 122. This can assist in guiding the endless track 70.

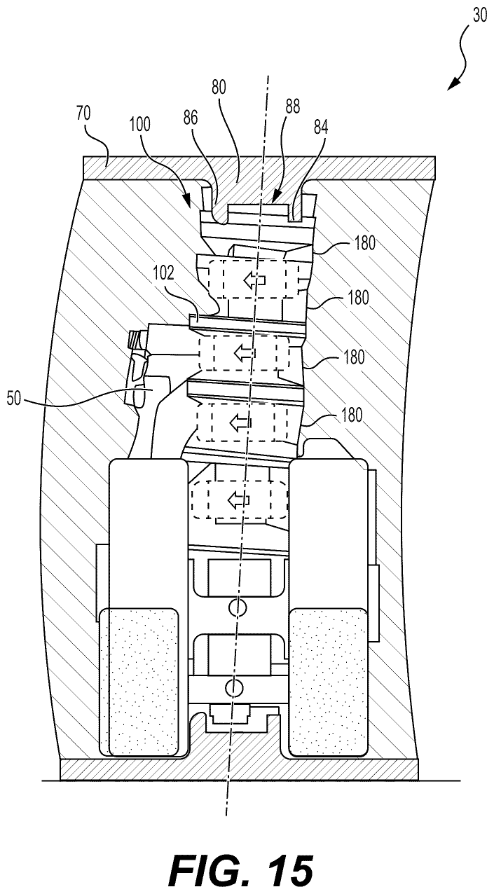

For example, referring to FIG. 15, the track system 30 is connected to the vehicle 10 with a camber angle. Thus, the drive wheel assembly 100, and thus the longitudinal center plane 110 of the drive wheel 102, is at an angle relative to a vertical plane extending in the longitudinal direction.

When the endless track 70 is subjected a lateral force, for example due to its contact patch, the configuration of the drive wheel 102 and its engagement with the lugs 80 can assist in guiding the endless track 70. Indeed, the engagement between the side support 180 and the base portion 82, which is the stiffer portion of the lug 80, can assist in aligning the endless track 70 with the drive wheel 102 to reduce likelihood of detracking. This is further assisted by the engagement between the extending portions 84, 86 and the drive wheel 102.

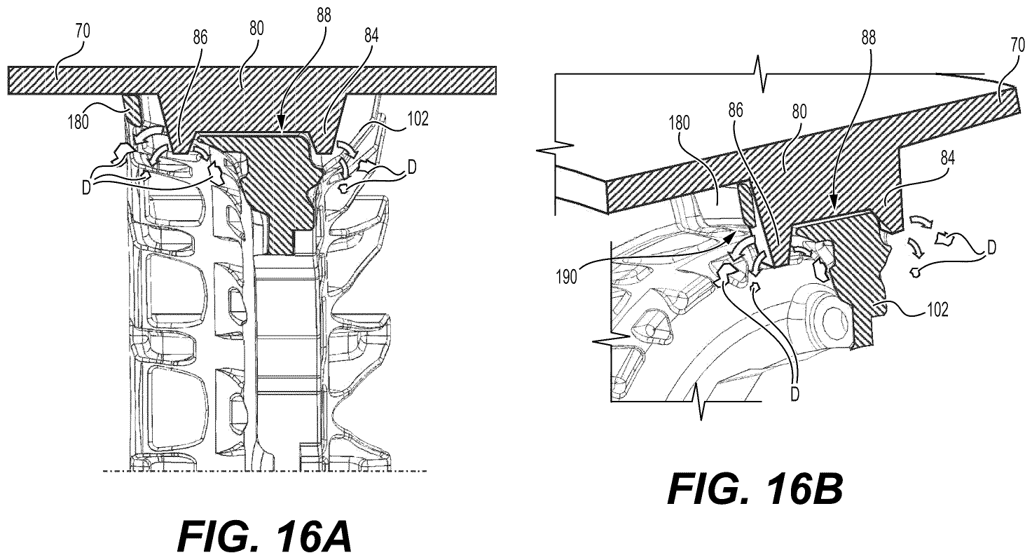

With reference to FIGS. 16A and 16B, it will also be noted that the presence of the side openings 190 can assist in evacuating debris D that may accumulate in the recesses 126. Over time, accumulation of debris in the recesses 126 may hinder the engagement between the drive wheel 102, which may increase likelihood of detracking. Additionally, accumulation and/or compaction of debris in the recesses 126 may also undesirably increase tension in the endless track 70, which could cause premature wear.

Additionally, with reference to the drive wheels 502, 602, 602′, the presence of the sloped sections 510, 610 can further assist in evacuating debris, which can extend life of the track system 30 and various components thereof, while also limiting compaction of debris. Also, the presence of the sloped sections 510, 610 can assist in reducing the number of surfaces that are parallel to one another between the drive wheels 502, 602, 602′ and the endless track 70. This can assist in reducing the buildup that may otherwise occur.

It will be noted that evacuation of debris via the drive wheel is particularly helpful, because tools such as scrappers may not be used. Indeed, sometimes, the track system 30 may be used in very harsh environments where snow enters from various sides, and build up occurs between lugs 80.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A drive wheel for a track system, the drive wheel comprising:
a hub portion;
a rim portion connected to the hub portion, the rim portion being disposed radially outwardly from the hub portion;
a plurality of engaging members connected to the rim portion, each one of the plurality of engaging members being angularly spaced from one another, and each one of the plurality of engaging members extending radially outwardly from the rim portion;
a plurality of recesses, each one of the plurality of recesses being defined between two adjacent engaging members of the plurality of engaging members, and being configured to receive an inner lug of a plurality of inner lugs of an endless track therein;
a side support connected to one of the plurality of engaging members, the side support extending toward an adjacent one of the plurality of engaging members, the side support being radially spaced from the rim portion; and
a side opening defined by the side support, a corresponding one of the plurality of engaging members, and part of the rim portion.

2. The drive wheel of claim 1, wherein:
the side support is configured to engage with a base of an inner lug of the plurality of inner lugs of the endless track; and
the side opening is configured to receive therethrough part of an inner lug of the plurality of inner lugs of the endless track.

3. The drive wheel of claim 1, wherein the side support extends from the one of the plurality of engaging members to an adjacent one of the plurality of engaging members.

4. The drive wheel of claim 1, wherein the side support further extends from the one of the plurality of engaging members toward an other adjacent one of the plurality of engaging members.

5. The drive wheel of claim 1, wherein the side support is spaced from the adjacent one of the plurality of engaging members.

6. The drive wheel of claim 1, wherein each one of the plurality of engaging members extends laterally beyond a first lateral side of the rim portion.

7. The drive wheel of claim 1, wherein the side support is one of a plurality of side supports, each one of the plurality of side supports being connected to a corresponding one of the plurality of engaging members.

8. The drive wheel of claim 7, wherein each one of the plurality of engaging members has a corresponding one of the plurality of the side supports connected thereto.

9. The drive wheel of claim 7, wherein at least one of the plurality of side supports is disposed on a first lateral side of the rim portion, and at least one other one of the plurality of side supports is disposed on a second lateral side of the rim portion.

10. The drive wheel of claim 1, wherein:
the side support is one of a plurality of side supports, each one of the plurality of side supports being connected to a corresponding one of the plurality of engaging members;
each one of the plurality of engaging members has a corresponding one of the plurality of the side supports connected thereto; and
the plurality of side supports forms a continuous side support structure, the continuous side support structure being laterally offset from a lateral side of the rim portion.

11. The drive wheel of claim 1, wherein the rim portion defines a plurality of sloped sections.

12. A track system comprising:
a frame;
a drive wheel assembly comprising the drive wheel according to claim 1, the drive wheel assembly being rotationally connected to the frame;
at least one support wheel assembly rotationally connected to the frame; and
an endless track comprising the plurality of inner lugs, the endless track surrounding the frame, the drive wheel assembly and the support wheel assembly.

13. A drive wheel for a track system, the drive wheel comprising:
a hub portion;
a rim portion connected to the hub portion, the rim portion being disposed radially outwardly from the hub portion;
a plurality of engaging members connected to the rim portion, each one of the plurality of engaging members being angularly spaced from one another, each one of the plurality of engaging members extending radially outwardly from the rim portion, and each one of the plurality of engaging members extending laterally beyond a first lateral side of the rim portion;
a plurality of recesses, each one of the plurality of recesses being defined between two adjacent engaging members of the plurality of engaging members, and being configured to receive an inner lug of a plurality of inner lugs of an endless track therein;
a plurality of side supports, each one of the plurality of side supports being connected to one of the plurality of engaging members, and extending toward an adjacent one of the plurality of engaging members, each one of the plurality of side supports being disposed laterally beyond the first lateral side of the rim portion; and
wherein each one of the plurality of engaging members has a corresponding one of the plurality of side supports.

14. The drive wheel of claim 13, further defining a plurality of the side recesses, each one of the plurality of side recesses being at least partially defined by a corresponding one of the plurality of side supports, a corresponding one of the plurality of engaging members, and part of the rim portion.

15. The drive wheel of claim 13, wherein:
the side support is configured to engage with a base of an inner lug of the plurality of inner lugs of the endless track; and
the side recess is configured to receive therethrough part of an inner lug of the plurality of inner lugs of the endless track.

16. The drive wheel of claim 13, wherein:
the side support extends from the one of the plurality of engaging members to an adjacent one of the plurality of engaging members; or the side support is spaced from the adjacent one of the plurality of engaging members.

17. The drive wheel of claim 16, wherein the side support further extends from the one of the plurality of engaging members toward an other adjacent one of the plurality of engaging members.

18. The drive wheel of claim 13, wherein:
the side support is one of a plurality of side supports, each one of the plurality of side supports being connected to a corresponding one of the plurality of engaging members;
each one of the plurality of engaging members has a corresponding one of the plurality of the side supports connected thereto; and
the plurality of side supports forms a continuous side support structure, the continuous side support structure being laterally offset from a lateral side of the rim portion.

19. The drive wheel of claim 13, wherein the rim portion defines a plurality of sloped sections.

20. A track system comprising:
a frame;
a drive wheel assembly comprising the drive wheel according to claim 13 rotationally connected to the frame;
at least one support wheel assembly rotationally connected to the frame; and
an endless track comprising the plurality of inner lugs, the endless track surrounding the frame, the drive wheel assembly and the support wheel assembly.
